(19) United States
(12) Patent Application Publication
(10) Pub. No.: US 2010/0085595 A1
(43) Pub. Date: Apr. 8, 2010

(54) Method and apparatus for high-speed inkjet printing

(76) Inventor: Robert M. Deets, II, Cochranton, PA (US)

Correspondence Address: FLOYD B. CAROTHERS;CAROTHERS AND CAROTHERS, 445 FORT PITT BOULEVARD, SUITE 200, PITTSBURGH, PA, 15219, US

(21) Appl. No.: 12/287,017

(22) Filed: Oct. 3, 2008

(51) Int. Cl. G06F 3/12

(52) U.S. Cl. 358/1.15

(57) ABSTRACT

Image data for printing an image on a printable medium at high speed with an inkjet printer is received in memory in the form of 512 pixels, or a multiple thereof, wide with a resolution of 360 dots per inch, and saved as an 8 bit color TIFF file with no compression and thereafter stripped into multiple printing columns, one for each color, the columns being positioned in a printing flow order with a spacing between columns of 512 pixels, or a multiple thereof, and then this stripped image data is saved as a four bit bitmap file. The printing medium objects are sequentially conveyed under the printheads whereby the stripped image data is printed onto the printing medium by the inkjet nozzle columns to generate the image. UV ink is employed, together with a UV curing light source to provide high-speed curing.

### BACKGROUND OF THE INVENTION

This invention relates to digital printing and more particularly to a method and apparatus for processing image data to provide high-speed digital printing, particularly inkjet printing.

The need exists for a non-complex high-speed ink jet printer for printing on a large series of objects or printable medium, such as golf balls, syringes, and containers. The image to be printed might typically be an advertising logo, a serial number or a bar code. For these applications, present day inkjet technology is overly complex, expensive and incapable of printing such objects at high speeds. Even the fastest of present day printers requires too much “pre-press” steps for setup and they still are not sufficiently fast.

The method and apparatus of the present invention simply does not presently exist and it will print on many types of substrates, such as plastic, metal, paper and cloth, at even faster printing speeds with extreme ease of setup. The printing apparatus of the present invention can also be provided in a portable form.

### SUMMARY OF THE INVENTION

The printing apparatus of the present invention incorporates a plurality of stationary printheads, each having a column of inkjet nozzles for respectively jetting a different color, wherein an image is recorded on a printable medium by conveying the printable medium respectively under the inkjet nozzle columns which are arranged in parallel in a direction perpendicular to the medium conveyance direction.

The columns of inkjet nozzles are spaced at intervals of 512 pixels, or a multiple thereof, along the medium conveyance direction. A processor is programmed for receiving image data in the form of 512 pixels, or a multiple thereof, wide at a resolution of 360 dots per inch and saving the data in memory as an 8 bit color TIFF file with no compression. The processor then strips the saved image data into multiple printing columns, one for each color, and positions the columns in a flowing order in the direction of printable medium conveyance with a spacing between columns of 512 pixels, or a multiple thereof, and then this strip image data is saved in memory as a 4 bit BMP (bitmap) file. The processor is associated with each printhead for distributing the stripped image data to respective of the printheads, whereby the stripped image data may be printed onto the printable medium by the inkjet nozzle columns to generate the image to be printed.

Typically there will be four colors, namely, cyan, magenta, yellow and black,(CMYK). However, additional colors may be included. Also, the printing flow order from front to back would typically, but not necessarily, be black, yellow, magenta and cyan. In addition, the ink used is preferably UV curable ink which is extremely fast drying, and a UV light source is positioned downstream from the printing heads in the conveyance direction of the medium to be printed.

Other jetable printing fluids can be substituted, for example, a primer or an overcoat.

The image is received into memory in the processor in the form of 512 pixels, or a multiple thereof, wide at a resolution of 360 dots per inch, and typically with an image length of up to 18 inches (65, 536 pixels).

Also, if desired, half toning of the stripped image may be accomplished with the software in conventional fashion.

For greyscale printing, levels of gray for the image data are received and converted from 256 levels to 4 levels, with levels 0-64 saved with a value of 0, levels 65-168 saved with a value of 1, levels of 129-192 saved with a value of 2, and levels of 193-256 saved with a value of 3.

### BRIEF DESCRIPTION OF THE DRAWINGS

Other objects and advantages appear hereinafter in the following description and claims, the appended drawings show, for the purpose of exemplification, without limiting the scope of the invention or the appended claims, certain practical embodiments of the present invention wherein:

FIG. 1 is a schematic block diagram illustrating a plan view of an embodiment of the printing apparatus of the present invention; and

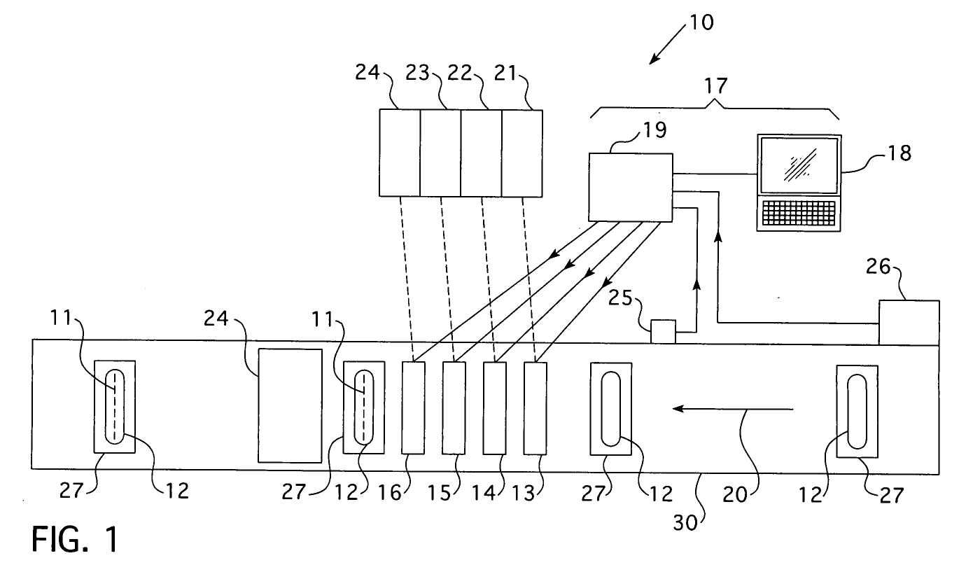

FIG. 2 is a computer screen operational flow chart illustrating the steps performed for printing startup, setup and run.

### DETAILED DESCRIPTION OF A PREFERRED EMBODIMENT

Referring to the drawing, portable printing apparatus 10 of the present invention is generally a portable device for inkjet printing of images 11 onto printable medium 12. The apparatus 10 includes a plurality of printheads 13, 14, 15 and 16, each having, in conventional fashion, an elongated array or column of inkjetting nozzles thereunder (not shown), one array for each color. The printheads 13-16, and their corresponding underlying arrays of jetting nozzles are positioned in parallel with each other with a spacing of 512 pixels. The spacing of 512 pixels may be doubled.

A processor 17, including PC 18 and sub-processor 19 receives image data of the image to be printed in the form of 512 pixels, or a multiple thereof, wide at a resolution of 360 dots per inch, and this image data is saved in data memory in PC 18 as an 8 bit color TIFF file with no compression. Then the saved image data is stripped into multiple printing columns, one for each color, and the columns are positioned in a printing flow order with a spacing between columns of 512 pixels, or a multiple thereof, and this stripped image data is saved in memory in the sub-processor 19 as a four bit BMP file. Sub-processor 19 is associated with each of the printheads 13-16 for distributing the stripped image data to respective of the printheads upon command for thereby printing the stripped image data onto the printable medium 12, 1 after the other, to generate the image to be printed.

The printheads 13-16 are stationary and the multiples of printable medium 12 are sequentially conveyed in one direction on linear conveyor 30 as indicated by arrow 20 under printheads 13-16 for printing an image 11 thereon. The printheads 13-16 are arranged respectively from front to back as black, yellow, cyan and magenta. This arrangement of course can be differed as long as the print management software corresponds. The printheads 13-16 are respectively continuously supplied with UV ink by gravity flow from respective color tanks 21, 22, 23 and 24. The ink tanks 21-24 are physically mounted to move with printheads 13-16 so that when the head height is changed the ink system moves accordingly, the printing can continue uninterrupted. An ultraviolet light source 24 is provided downstream from printheads 13-16 for quickly curing the UV ink images 11 as they pass thereunder.

Sub-processor 19 receives a conveyor speed signal from shaft encoder 26, and along with a signal from print trigger 25, which is a position indicator, and the sub-processor 19 therefore knows when a printable medium 12 is positioned underneath the respective printheads, and the image retrieved from memory and the image information, along with the timing and routing data is sent to the respective printheads which then sequentially shoot or jet ink drops at the correct time to provide the printed image.

Each of the printable mediums 12 is conveyed on the conveyor with a fixture or pallet 27 holding the respective objects or principal mediums 12 in place in order to move them and properly position them underneath the printheads 13-16 as the conveyor 30 moves along. The print trigger 25 is an optical switch which is triggered when a pallet 27 loaded with the medium 12 to be printed moves past it. A printhead clock is generated by digital rotary encoder 26 which reads the degree of revolution of the conveyor drive shaft to tell the heads 13-16 what sequential speed to print. The UV light source 44 is also turned on when the pallet 27 goes past and turns off when the part has gone beyond the UV light.

The entire printer 10 is preferably portable and mobile so that it can be easily relocated for different print jobs. Also, the conveyor 30, instead of being a conveyor belt as shown, can consist of a rotating head which spins conical or cylindrical medium 12 to be printed under the printheads 13-16. In this latter instance the clock can also be used to synchronize printing with the speed of the rotating pieces for printing.

Besides UV color ink, other jetable fluids may be utilized in the printer and method of the present invention, such as a primer or an overcoat. The stripped image may also be half toned as desired in a conventional manner in the software.

Levels of grey may be also printed and levels of grey for the image data are received and converted in PC 18 from 256 levels to 4 levels, with levels 0-64 saved with a value of 0, level 65-128 saved with a value of 1, levels of 129-192 saved with a value of 2, and levels of 193-256 saved with a value of 3. In this greyscale mode print speed is adjustable up to about 300 mm/sec. In the Binary color mode previously explained, print speed is adjustable up to about 500 mm/sec.

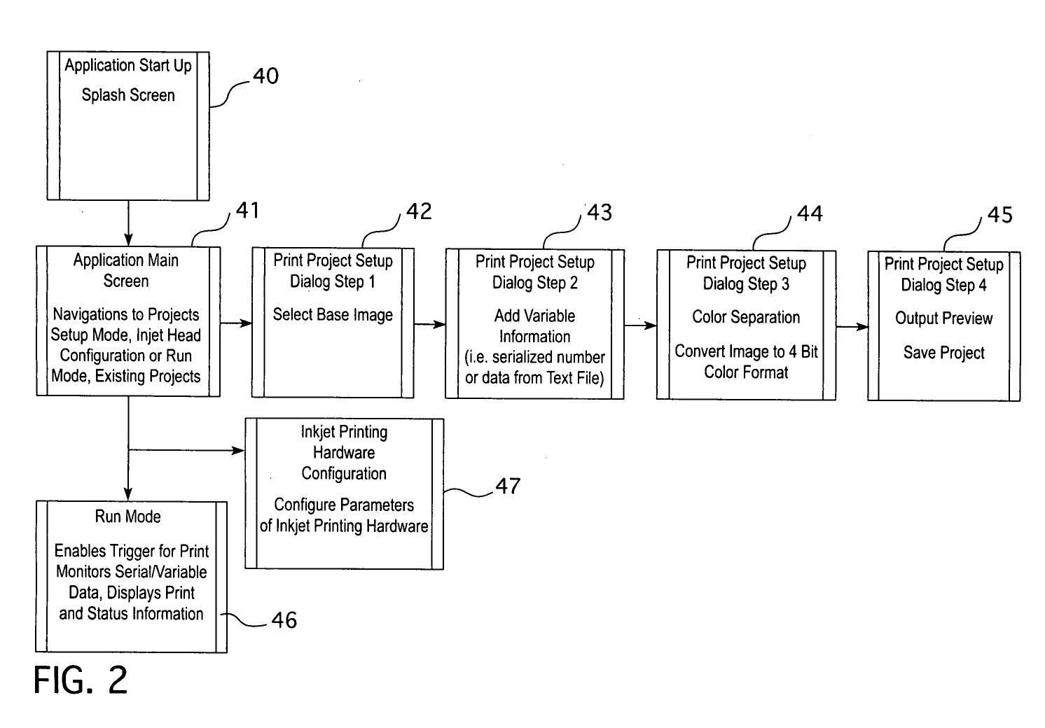

Referring next to the flow chart of FIG. 2, a print project setup and print run utilizing the apparatus 10 will be explained. The software application supports the use of the scribe Velocity Print System™.

The following definitions will be used in this explanation:
Print Object—The object to be printed, print medium (12).

Inkjet Printing Hardware—Commercially purchased components consisting of Inkjet Heads 13-16, Electronic Control Hardware and PC Interface Hardware (17, 18, 19, 25, 26, 30 etc.).
Print Conveyor—A linear conveyor (30) that transports the Print Object underneath the Inkjet Printing Hardware.
Pallet—A component fixture or pallet (27) that is designed to hold the Print Object in place as it moves on the Print Conveyor. Multiple Pallets are attached to the conveyor.
Print Operation—An operation wherein a Print Object is loaded into a Pallet, which passes a trigger device (25) and thereby initiates printing, and then exiting of the Print Object from the system.
Application—Application in this instance is software developed by Visual Studio.net as a Visual Basic Application. The developed software will run as a Windows™ Application and is intended to configure and support the Velocity Print System™.
Print Project—A collection of user defined files and settings that will control the Print Operation. The Application will store Print Projects and allow future use or modifications.
Application Output—A file, in a specific format specified by the Inkjet Printing Hardware manufacturer that will be uploaded to the Inkjet Printing Hardware in preparation for a Print Operation.

The operational flow chart of FIG. 2 will now be explained with reference to the respective chart screens displayed.

Application Startup (Screen 40)—The User will start the Application through normal means common to the Microsoft™ Windows Platform (a desktop shortcut or by navigation through the Start Menu). A splash screen will be displayed showing the current software revision and copyright information. During this time, any drivers or communications paths will be loaded and established. After completion, the Application will close the splash screen and display the Main Screen.

Main Screen (41)—The main screen will provide navigation to 3 objectives, namely, Print Project setup (Screens 42 through 45), Inkjet Printing Hardware configuration (Screen 47), or Run Mode (Screen 46). The main screen will also allow the user to open an existing Print Project.

Print Project Setup—Setting up a Print Project requires 4 steps.

Step 1 (Screen 42)—The user will select a base image. The base image will be an image file in either a BMP file format or a TIFF file format. The base image will serve as the backdrop to the Application Output.

Step 2 (Screen 43)—The user will add and configure variables that will be added to the base image selected in Step 1. Variable information can be one of the following three types:
Static Text—Text that will not change from Print Operation to Print Operation.
Serialized Data—A number (8 byte long data format, 0 to 9,223,372,036,854,775,807) that will increment by a value of 1 for each Print Operation.
Variable Text Data—Data that will be retrieved from an existing file and will update each Print Operation. For example, a list of names stored in a spreadsheet would be selected as the variable source. The first Print Operation will print the name in column 1, row 1, the second Print Operation would print column 1, row 2 etc. . . . Each variable type will be user configurable for font type, size and color. The location of the variable will be set in X and Y coordinate values in units of Pixels. A particular Print Project may not require variables. If so, the user would have the option to skip Step 2. A project with no variable data wold simply print the base image.

Step 3 (Screen 44)—The user will define color separation values.

Step 4 (Screen 45)—The user will preview the final output file and save the Print Project. If changes are required, the user will be capable of navigating back to any of the previous steps.

Inkjet Printer Hardware Configuration (Screen 47)—The user will configure settings specific to the operation of the Inkjet Printing Hardware. These settings accommodate for minor differences in the mounting and positioning of the Inkjet Printing Hardware. These settings would only be required after initial setup of the system and after maintenance operations.

Run Mode (Screen 46)—After a Print Project has been created or loaded, the user will navigate to the Run Screen 46. While in run mode, the Application will monitor the Inkjet Printing Hardware and coordinate Print Operations. A Print Operation begins when the Inkjet Printing Hardware receives a trigger signal from a sensor (25) mounted to the Print Conveyor. After completion of the Print Operation the Application will review the settings of the Print Project and update variable information (if applicable) and upload data to the Inkjet Printing Hardware in preparation for the next Print Operation.

During run mode, current variable data will be displayed, for example, if a Print Project contained a serialized variable, the display would show a starting value of 1. After the first Print Operation, the display would show 2 etc. . . . This display will also allow the user to change the current serial number. For example, if the user wishes to start at serial number 100235, they can click on the display window and enter that value. Subsequent Print Operations will continue advancing from that number. A counter will display the current number of Print Operations that have occurred since Run Mode was started. An on screen button will allow the counter to be reset.

I claim:

1. A method for processing image data for printing on a printable medium, comprising the steps of:
receiving the image data in the form of 512 pixels, or a multiple thereof, wide at a resolution of 360 dots per inch;
saving the image data as an 8 bit color TIFF file with no compression;
stripping the saved image data into multiple printing columns, one for each color, and positioning the columns in a printing flow order with a spacing between columns of 512 pixels, or a multiple thereof; and
saving this stripped image data as a 4 bit BMP file.

2. The method of claim 1, wherein there are four of said colors, namely, black, yellow, magenta and cyan.

3. The method of claim 2, wherein the printing flow order of said columns is black, yellow, magenta and cyan.

4. The method of claim 1, wherein said image data includes an image length of up to 18 inches.

5. The method of claim 1, wherein levels of gray for said image data are received and converted from 256 levels to 4 levels, with levels 0-64 saved with a value of 0, levels 65-128 saved with a value of 1, levels of 129-192 saved with a value of 2, and levels of 193-256 saved with a value of 4.

6. The method of claim 1, including halftoning the stripped image.

7. A printing apparatus for printing an image represented by image data onto printable medium, comprising;
a plurality of printheads, each having an elongated array of ink jetting nozzles; one array for each color, said arrays positioned in parallel with each other with a spacing of 512 pixels, or a multiple thereof;
a processor programmed for receiving the image data in the form of 512 pixels, or a multiple thereof, wide at a resolution of 360 dots per inch and saving the data in memory as an 8 bit color TIFF file with no compression, and for stripping the saved image data into multiple printing columns, one for each color, and positioning the columns in a printing flow order with a spacing between columns of 512 pixels, or a multiple thereof, and saving this stripped image data in memory as a 4 bit BMP file;
said processor associated with each printhead for distributing the stripped image data to respective of said printheads;
whereby the stripped image data may be printed onto the printable medium to generate the image to be printed.

8. The printing apparatus of claim 7, wherein said printheads are stationary and multiples of the printable medium are sequentially conveyed in one direction under said printheads for printing an image thereon.

9. The printing apparatus of claim 8, wherein the direction of elongation of said arrays is transverse to said one direction of conveyance.

10. The printing apparatus of claim 9, wherein there are four of said colors, namely, black, yellow, magenta and cyan.

11. The printing apparatus of claim 10, wherein said printing flow order from front to back along the one direction of conveyance is black, yellow, magenta and cyan.

12. The printing apparatus of claim 7, wherein ink used in said apparatus for printing is UV curable ink.

13. The printing apparatus of claim 7, wherein ink used in said apparatus for printing includes the jetable fluids of primer or overcoat.

14. The printing apparatus of claim 7, wherein levels of gray for said image data are received and converted from 256 levels to 4 levels, with levels 0-64 saved with a value of 0, levels 65-128 saved with a value of 1, levels of 129-192 saved with a value of 2, and levels of 193-256 saved with a value of 3.

15. An inkjet printer comprising:
a plurality of printheads, each having a column of inkjet nozzles, each column for respectively jetting a different color;
wherein an image is recorded on a printable medium by conveying the printable medium respectively under the inkjet nozzle columns which are arranged in parallel in a direction perpendicular to the medium conveyance direction;
said columns of inkjet nozzles being spaced at intervals of 512 pixels, or a multiple thereof, along the medium conveyance direction;
a processor programmed for receiving image data in the form of 512 pixels, or a multiple thereof, wide at a resolution 360 dots per inch and saving the data in memory as an 8 bit color TIFF file with no compression, and for stripping the saved image data into multiple printing columns, one for each color, and positioning the columns in a flowing order in the direction of printable medium conveyance with a spacing between columns of 512 pixels, or a multiple thereof, and saving this stripped image data in memory as a 4 bit BMP file; and
said processor associated with each printhead for distributing the stripped image data to respective of said printheads;
whereby the stripped image data may be printed onto the printable medium by said inkjet nozzle columns to generate the image to be printed.

16. The inkjet printer of claim 15, wherein there are four of said colors, namely, black, yellow, magenta and cyan.

17. The inkjet printer of claim 16, wherein said printing flow order from front to back along the direction of conveyance is black, yellow, magenta and cyan.

18. The inkjet printer of claim 15, wherein ink used in said apparatus for printing is UV curable ink.

19. The printing apparatus of claim 15, wherein ink used in said apparatus for printing includes the jetable fluids of primer or overcoat.

20. The printing apparatus of claim 15, wherein levels of gray for said image data are received and converted from 256 levels to 4 levels, with levels 0-64 saved with a value of 0, levels 65-128 saved with a value of 1, levels of 129-192 saved with a value of 2, and levels of 193-256 saved with a value of 3.
